(19) United States
(12) Patent Application Publication
(10) Pub. No.: US 2005/0230063 A1
(43) Pub. Date: Oct. 20, 2005

(54) Slat structure for Venetian blind

(76) Inventor: Shi Yang Hwang, Kaohsiung (TW)

Correspondence Address: TROXELL LAW OFFICE PLLC, SUITE 1404, 5205 LEESBURG PIKE, FALLS CHURCH, VA, 22041, US

(21) Appl. No.: 10/867,669

(22) Filed: Jun. 16, 2004

(30) Foreign Application Priority Data
Apr. 14, 2004 (TW) 093205728

(51) Int. Cl. E06B 3/08

(52) U.S. Cl. 160/236

(57) ABSTRACT

A slat structure for a Venetian blind includes an upper and a lower beam with a ladder rope and a retaining cord mounted there-between to operatively work with a plurality of slats thereby wherein the slat is made of a flexible slat piece having a supporting member of a proper thickness integrally combined with engaging edges disposed at both longitudinal sides thereon respectively. The supporting member can be made of transparent, non-transparent, or mixed-color fastening plastic material that is capable of being molded in various shapes such as a round column-like rod, a triangular elongated rod, or a rectangular elongated rod, etc., economically facilitating an easy and fast production and assembly of the Venetian blind thereof. Besides, both the upper/lower sides and the sectional side of the engaging edges of each blind slat are precisely bound at the supporting members therein without any gaps produced there-between, efficiently boosting the beauty of the Venetian blind thereof as a whole.

### BACKGROUND OF THE INVENTION

The present invention is related to a slat structure for a Venetian blind, including an upper and a lower beam with a ladder rope and a retaining cord mounted there-between to operatively work with a plurality of slats thereby wherein each slat has engaging edges disposed at both longitudinal sides thereon for a supporting member of a proper thickness to be integrally bound therewith respectively, and the supporting member can be made of transparent, non-transparent, or mixed-color fastening plastic material that is capable of being molded in various shapes such as a round column-like rod, a triangular elongated bar, or a rectangular elongated bar, etc., economically facilitating an easy and fast processing and assembly of the Venetian blind thereof Besides, the engaging edges of each blind slat are integrally combined with the supporting members thereof without any gaps produced there-between, efficiently boosting the beauty of the Venetian blind thereof as a whole.

Please refer to FIGS. 1 to 2 inclusive. A conventional slat structure for a Venetian blind includes a Venetian blind 10 having a ladder rope 13 and a retaining cord 14 mounted at an upper and a lower beam 11, 12 there-between to operatively work with a plurality of blind slats 15 thereby. The blind slat 15 is made of a flexible woven piece 151 having a tubular engaging hole 152 disposed at both longitudinal sides thereon respectively for a stiff supporting rod 16 to be joined therein to expand the blind slat 15 horizontally for location thereby.

There are some drawbacks to such conventional slat structure for a Venetian blind. First, the tubular engaging holes 152 must be further processed in the weaving operation of the blind slats 15 before the supporting rods 16, individually made in advance, are sequentially mounted and located into the tubular engaging holes 152 disposed at both longitudinal sides of the blind slat 15 thereof, which, numerous in assembly parts, is both complicated and time-consuming in assembly as well as production. Second, when the supporting rods 16 are mounted to the tubular engaging holes 152, gaps A as shown in FIGS. 1, 2 are easily produced there-between, which can unstably shake the supporting rods 16 at the retaining holes 152 therein when the blind slats 15 are shifted in angles via the ladder rope 13 thereof, and can even make the ends of the supporting rods 16 protruding outside the tubular engaging holes 152 thereof. Thus, the supporting rods 16 must be pushed one by one and relocated at the tubular engaging holes 152 therein before the ladder rope 13 and the retaining cord 14 can proceed with the operation thereof, which is very inconvenient in practical use. Third, via the gaps A exposed at the tubular engaging holes 152 therein as shown in FIGS. 1, 2, the supporting rods 16 can be directly seen through the tubular engaging holes 152 thereby, which can mar the overall beauty of the Venetian blind 10 thereof

### SUMMARY OF THE PRESENT INVENTION

It is, therefore, the primary purpose of the present invention to provide a slat structure for a Venetian blind, including an upper and a lower beam with a ladder rope and a retaining cord mounted there-between to operatively work with a plurality of slats thereby wherein each blind slat has engaging edges disposed at both longitudinal sides thereon for a supporting member of a proper thickness to be integrally bound therewith respectively without any other tubular engaging holes and supporting rods of a conventional slat structure required, facilitating an easy and fast processing and assembly of the slat structure thereof to achieve economical efficiency and competitive power thereof.

It is, therefore, the second purpose of the present invention to provide a slat structure for a Venetian blind wherein the supporting members are directly and stably bound with the engaging edges disposed at both longitudinal sides of each blind slat thereof so that the supporting members are securely refrained from shaking when the slats are shifted in angles according to the ladder rope, effecting a more precise and smooth operation thereof to achieve the best using condition thereof It is, therefore, the third purpose of the present invention to provide a slat structure for a Venetian blind wherein the supporting members are integrally combined with the engaging edges of the blind slats without any other gaps produced there-between, efficiently boosting the beauty of the Venetian blind thereof as a whole.

### BRIEF DESCRIPTION OF THE DRAWINGS

FIG. 1 is a perspective view of a conventional slat structure for Venetian blind in assembly.

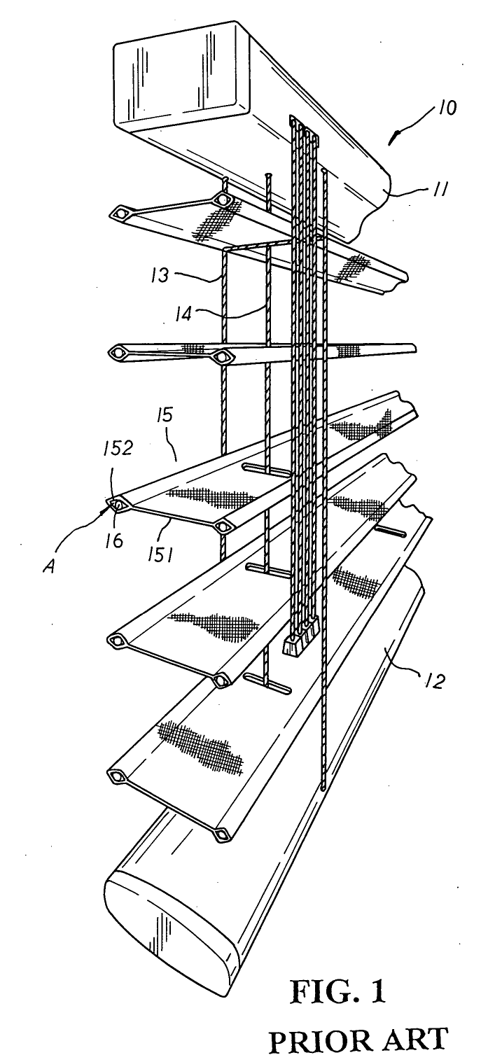

FIG. 2 is a perspective view of a slat of the conventional slat structure for Venetian blind.

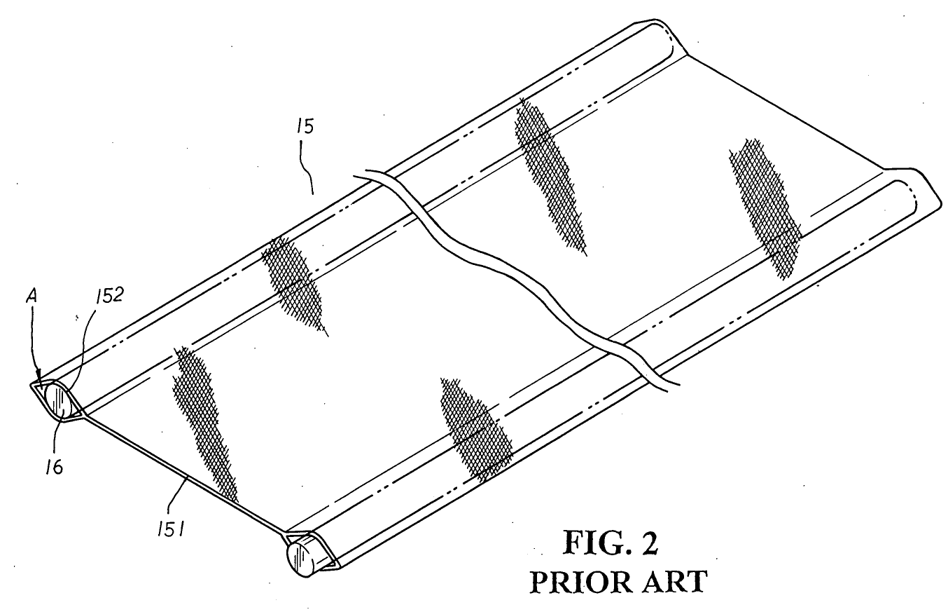

FIG. 3 is perspective view of the present invention in assembly.

FIG. 4 is a perspective view of a slat of the present invention.

FIG. 5 is a perspective view of another embodiment of the slat of the present invention.

FIG. 6 is a perspective view of a third embodiment of the slat of the present invention.

### DETAILED DESCRIPTION OF THE PREFERRED EMBODIMENTS

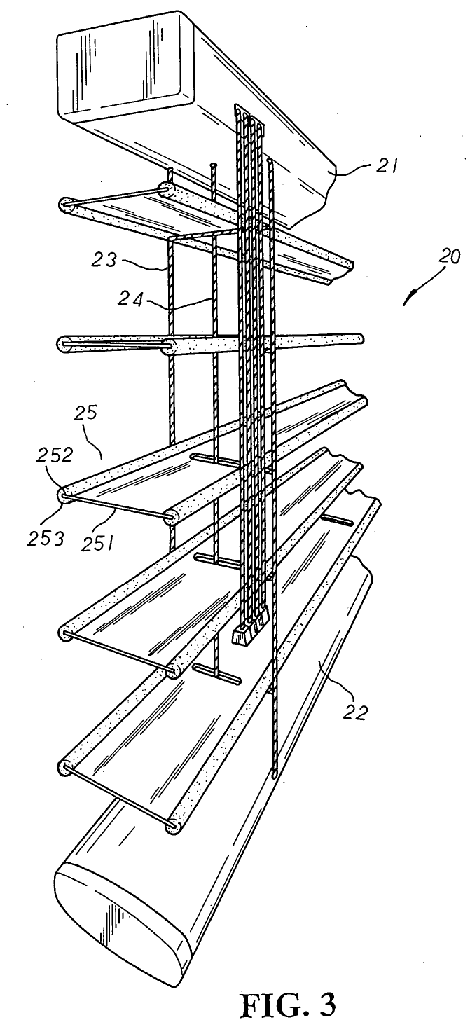

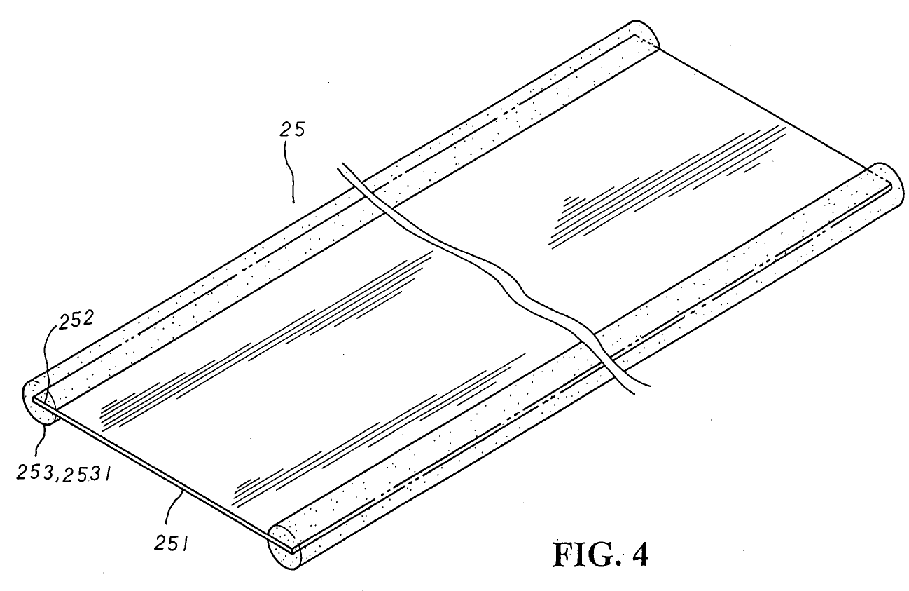

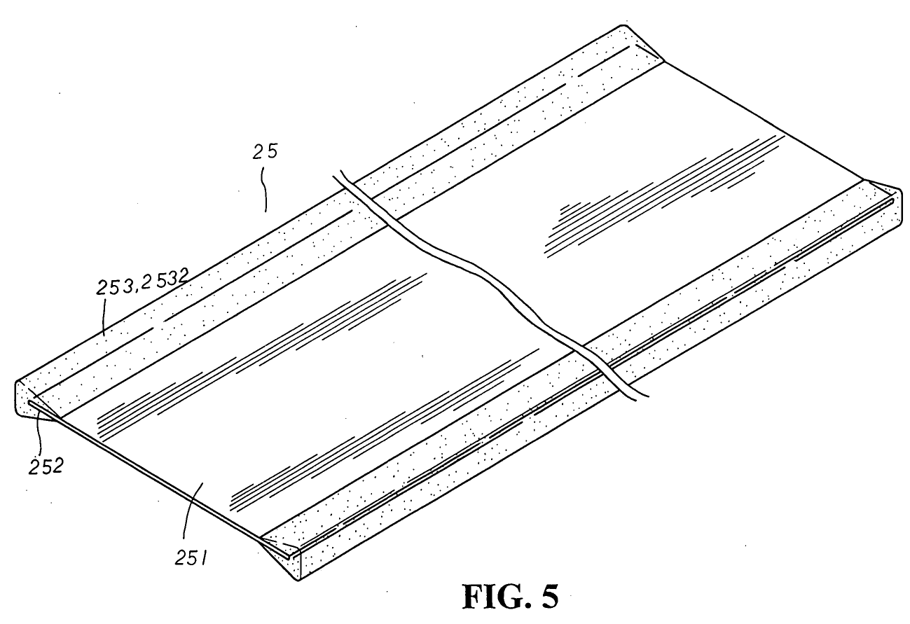

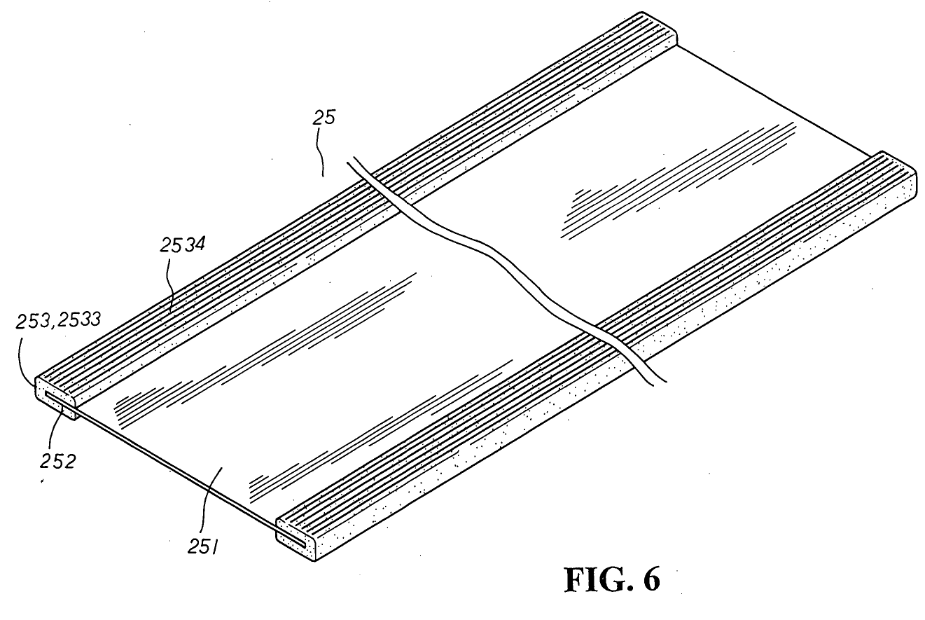

Please refer to FIGS. 3 to 4 inclusive. The present invention is related to a slat structure for a Venetian blind, including a Venetian blind 20 made up of an upper and a lower beam 21, 22, a ladder rope 23 and a retaining cord 24 mounted at the upper and lower beams 21, 22 there-between to operatively work a plurality of slats 25 thereby. The slat 25 is made of a flexible slat piece 251 having engaging edges 252 disposed at both longitudinal sides thereon to which a supporting member 253 of a proper thickness is securely attached respectively. The supporting member 253, integrally coated at both the upper and lower sides and the sectional side of the engaging edge 252 of the blind slat 25 thereof, can be made of transparent, non-transparent, or mixed-color fastening plastic material that are capable of being molded in various shapes such as a round column-like rod 2531 as shown in FIG. 3, a triangular elongated bar 2532 as shown in FIG. 5, or a rectangular elongated bar 2533 as shown in FIG. 6. And a decoration area 2534 can also be disposed at the surfaces of the supporting member 253 thereon to provide rib-like or other patterns thereon as shown in FIG. 6. Thus, the slats 25 are produced and mounted in an easy and fast manner without any tubular engaging holes and supporting rods of the conventional slat structure required, and the engaging edges 253 disposed at the longitudinal sides thereof are precisely bound at the supporting members 253 therein without any gaps produced there-between, efficiently boosting the beauty of the Venetian blind 20 thereof as a whole.

1. A slat structure for a Venetian blind, including a Venetian blind made up of an upper and a lower beam with a ladder rope and a retaining cord mounted there-between to operatively work with a plurality of slats thereby wherein the slat is made of a flexible slat piece and is characterized by that,
the slat piece having a supporting member of a proper thickness integrally combined with engaging edges disposed at both longitudinal sides thereon respectively without any tubular engaging holes and supporting rods of a conventional slat structure required, economically facilitating an easy and fast production and assembly thereof, besides, both the upper/lower sides and the sectional side of the engaging edges of each blind slat being precisely bound at the supporting member therein without any gaps produced there-between, efficiently boosting the beauty of the Venetian blind thereof as a whole.

2. The slat structure for a Venetian blind as claimed in claim 1 wherein the supporting member thereof can be molded in various shapes such as a round column-like rod, a triangular elongated bar, or a rectangular elongated bar, etc.

3. The slat structure for a Venetian blind as claimed in claim 1 wherein the supporting member can be made of transparent, non-transparent, or mixed-color fastening plastic material.

4. The slat structure for a Venetian blind as claimed in claim 1 wherein the supporting member can also have a decoration area with various patterns and designs disposed at the surfaces thereon.

5. The slat structure for a Venetian blind as claimed in claim 1 wherein the decoration area of the supporting member can have rib-like patterns disposed at the surfaces thereon.
